(19) United States
(12) Patent Application Publication
(10) Pub. No.: US 2002/0184041 A1
(43) Pub. Date: Dec. 5, 2002

(54) Automated customer survey using the web

(75) Inventor: Donald P. Muller, Highland, NY (US)

Correspondence Address: Floyd A. Gonzalez, IBM Corporation, 2455 South Road, P386, Poughkeepsie, NY, 12601, US

(73) Assignee: International Business Machines Corporation, Armonk, NY (US)

(21) Appl. No.: 09/870,758

(22) Filed: May 31, 2001

(51) Int. Cl. G06F 17/60

(52) U.S. Cl. 705/1

(57) ABSTRACT

A method, system and program product for providing a survey tool which creates a customer database and sends a survey questionnaire to be posted on a web server. The survey tool then sends emails to qualifying customers wherein each email contains customer information and a link to the customer database such that when the customer clicks on the link and completes the survey questionnaire on the web server, the completed survey and customer information is sent to the customer database. The survey tool creates a unique URL which is placed in the email to each customer such that the customer may click on the URL and link to the web survey without having to sign on to the web site with a password or other authentication.

### BACKGROUND OF THE INVENTION

The present invention relates to an Internet software tool, and more particularly relates to a web survey tool for conducting automating customer surveys.

U.S. Pat. No. 5,893,098 issued Apr. 6, 1999 to Peters et al. for SYSTEM AND METHOD FOR OBTAINING AND COLLATING SURVEY INFORMATION FROM A PLURALITY OF COMPUTER USERS, discloses a system for obtaining information from a plurality of computer users, and an input mechanism by which a survey author may input data. A survey authoring mechanism enables construction of a survey questionnaire document including at least one question formulated from data input by the survey author. The survey questionnaire document is transmitted to a plurality of respondent users who respond to the questionnaire with a response document. A collating mechanism identifies the response documents which include responses to the at least one question. The answers are loaded into a database in accordance with the responses.

U.S. Pat. No. 6,189,029 issued Feb. 13, 2001 to Fuerst for WEB SURVEY TOOL BUILDER AND RESULT COMPILER, discloses a software tool that permits the creation of electronic surveys and the automatic collection and tabulation of survey results corresponding to user responses.

A web based survey tool is provided by Aufrance Associates of South Lake Tahoe, Calif., and is available at:

Highsierra.com/highsierra/survey.htm

Another web based survey tool is provided by Datalnstitutet i Sverige AB of Gothenburg, Sweden, and is available at:

www. surveyagent.com/eng

One of the services provided by Datainstitutet is SurveyAgent 2—E-mail with a “Personal ID-code”. In this service, a questionnaire is created by the customer subscriber and delivered to Datainstitutet, where it is convered into a web form and uploaded. The customer sends the e-mail addresses of the participants as a text-file to Datainstitutet. Each respondent receives, via e-mail, a hyperlink to the questionnaire with a unique password for montoring participant authenticity as well as ensuring that only one response per participant is submitted. When the survey is completed, Datainstitutet returns the questionnaire, as well as the respondents' data, in a business intelligence file to the customer. The business intelligence file enables the customer to analyze, make statistic calculations and present the results.

### SUMMARY OF THE INVENTION

The traditional method of surveying customers is by a manual operation, or if automated, than the confidentiality of data collected by the survey is either compromised or requires a separate authentication for each customer.

This tool allows a confidential survey to be automatically generated and emailed to eliminate the need for customers to call, for instance, a Help Desk. In the present invention, a query is run against a Help Desk problem record tracking database to extract those records which have been closed and are eligible to be surveyed. Rules may include all problem records of a particular type, customers or users of a specific group, and/or how frequently a survey to specific end user is to be made (i.e. only once per a particular time frame). In the present implementation, the query is run by an agent in a Lotus Domino database. The Customer Satisfaction tool takes advantage of the Lotus Domino server to generate a unique Universal Resource Locator (URL) for each survey. This unique URL is an improvement over previous survey tools which required the user to be assigned a user name or password for authentication. In the present invention, the URL is imbedded into an email which is sent to the customer who initiated the problem record. The customer then uses the URL by either launching a browser link or by cutting-and-pasting the URL to their browser. (This is dependent on the mail tool's ability to launch the browser.) The customer is presented with a web site page that has been customized to that customer and is only accessible through this unique URL. When the survey has been completed and saved by the customer, the customer may not re-enter the web site page, thus preventing duplicate entries of the survey. The present invention provides a way of conducting a survey through either an internet or intranet link and eliminates the problem of establishing user name/password authentications or conducting surveys by placing manual calls to the customers to be surveyed

It is an object of the present invention to provide a survey tool which creates a customer database and sends a survey questionnaire to be posted on a web server, sends emails to qualifying customers which contain customer information and a link to the customer database such that when the customer clicks on the link and completes the survey questionnaire on the web server, the completed survey and customer information is sent to the customer database.

It is another object of the present invention to provide a survey tool in which a unique URL is created for each customer and placed in the email to that customer such that the customer may click on the URL and link to the survey questionnaire on the web server without having to sign on with a password or other authentication.

It is another object of the present invention to provide a survey tool which propagates the survey questionnaire through a firewall to the web server, and which propagates the completed survey and customer information back through the firewall from the web server for analysis.

It is another object of the present invention to provide a survey tool which prevents a customer from linking to the survey questionnaire on the web server after first entering, completing, and saving the completed survey to prevent the survey from being answered more than once by a customer.

These and other objects will be apparent to one skilled in the art from the following drawings and detailed description of the invention.

### BRIEF DESCRIPTION OF THE DRAWINGS

The accompanying drawings illustrate the invention as follows:

FIG. 1 is a schematic drawing of a computer network usable with the present invention including an intranet for constructing a survey and analyzing the survey after completion by a customer, and an internet wherein the web is used to communicate with customers to be surveyed; and

FIG. 2 is a flow diagram showing the flow of a tool for constructing a survey, sending it to a customer, and analyzing the results of the survey after being completed by a customer.

### DESCRIPTION OF THE PREFERRED EMBODIMENT

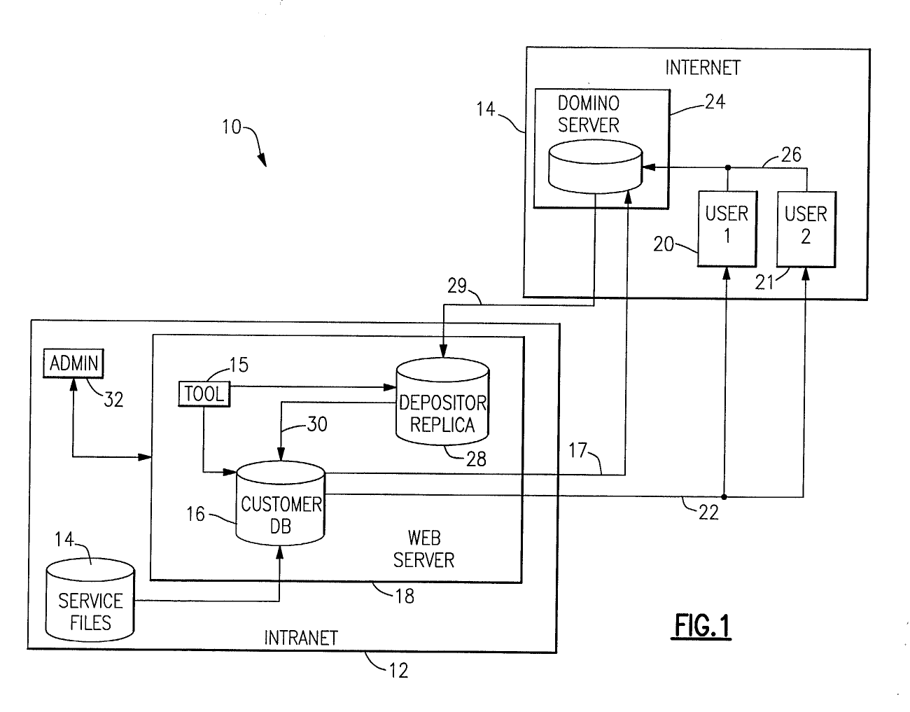

FIG. 1 is a diagram of a system 10 which includes an intranet 12 and a portion of the internet 14. As is known, the internet 14 is a global collection of computer networks that provides individual users the ability to access internet services including the world wide web (web). With internet access, individual users may, among other functions, send electronic mail (also known as email) to other users and remotely login to computers known as servers which are connected to the internet. Connecting to the internet requires a modem, a software communication package and a personal computer system, as well known in the art.

As is well known in the art, the web is a collection of Hypertext Transfer Protocol (HTTP) servers that incorporate text, graphics, audio files, video, and information in other formats. Various web browsers enable users to locate and connect to a web page. Before the web page may be located however, it must first be created in, for instance, Hypertext Markup Language (HTML), which is the standard language of the Web, and posted on a server.

In the intranet 12, service files 14 are maintained which indicate users of various customer services such as, for instance, help desk facilities. After each use of the help desk, or at some specified interval, it is desirable to ask the customer to complete a survey to determine the customer satisfaction with the help desk. In the present invention, a customer satisfaction tool 15 pulls closed ticket information and email addresses for the customer user of the help desk from the services files 14 and places them in a customer database 16 on a web server 18 in the intranet 12. The web server 18 may be a Netfinity 3500 web server available from International Business Machines Corporation (IBM) of Armonk, N.Y. The tool 15 will generate documents for each closed ticket and generate email addresses. In preparation for customer responses, the tool sends a customer survey or questionnaire from the customer database 16 to a server 24 in the internet 14, as indicated at 17. The web server 24 may be a Lotus Domino server available from IBM.

An email having a link to the customer database 16 will be sent to each customer 20 (User 1) and 21 (User 2), as indicated at 22 in FIG. 1. Each email and link will contain information identifying its respective customer. The tool 15 takes advantage of the Lotus Domino server 24 to generate a unique URL link for each survey. The URL is imbedded in the email sent to the customer or end user who initiated the problem record at the help desk. The customers 20 and 21 will then click the link in their respective emails which will link the customers to the web server 24, as shown at 26, which has been previously prepared at 17. The customer is thus able to link to the unique URL generated for that customer without having to sign on with a password or other authentication. The web server 24 will show a form to the responding customer, which may be a questionnaire such as, for instance, a customer satisfaction questionnaire. If the mail tool of end user is not able to launch the browser, that end user may cut-and-paste the URL to the browser. The end user is presented with a web site page that has been customized to that end user, and is only accessible through this unique URL. When the survey has been completed and saved, the user may not re-enter the web site page.

After the survey or questionnaire is completed and saved by the end user, the data is propagated down to a depositor replica 28, as shown at 29, where the data will be accessible to the tool 15. The tool 15 pulls the data from the replica 28 and stores it in the customer database 16, as shown at 30, where the data is stored. The tool 15 does any report processing necessary for the data to be viewed for measurements. Finally, the reports are viewed by an administrator 32 for analyzing and evaluating customer satisfaction from the processed data. It will be understood that completed help desk tickets and customer satisfaction are exemplary only, and that the present invention may be used to send questionnaires and surveys of a wide variety using the present invention.

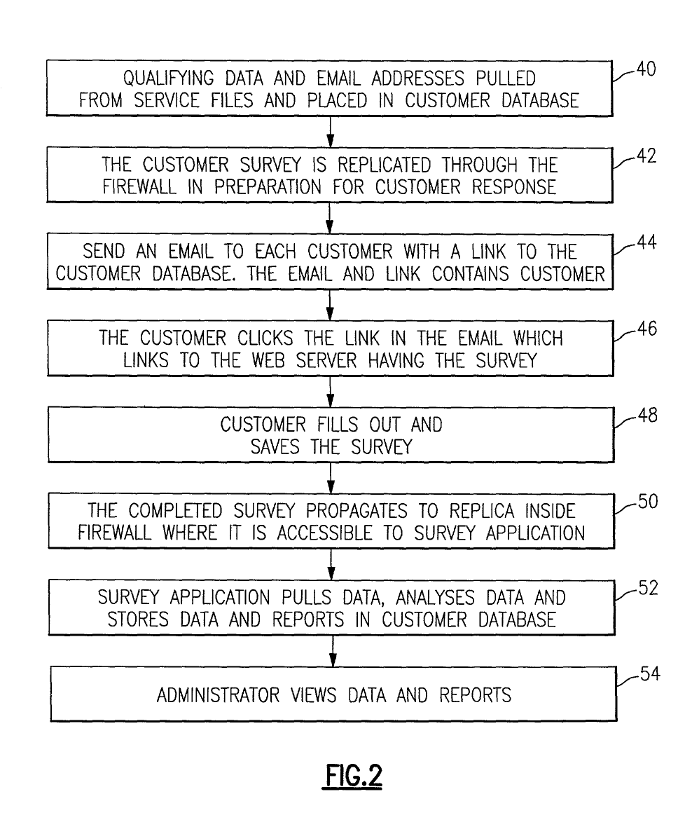

FIG. 2 is a flow chart showing the process of the present invention. At 40, qualifying data and email addresses are pulled from service files and placed on a customer database. At 42, a customer survey is replicated through the firewall to a web server in preparation for customer responses. At 44, an email is sent to each qualifying customer with a unique link to the customer database, preferably by way of the web server. The email and link contain customer identifying information. At 46, the customer who receives the email clicks the link in the email which links to the web server having the survey. At 48, the customer fills out and saves the survey. At 50, the completed survey propagates to a replica inside the firewall where it is accessible to the survey application or tool. At 52, the survey tool pulls the data, analyzes the data into reports, and stores the data and reports in the customer database. At 54, an administrator views the data and reports, as desired.

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. A method for surveying customers having data in computer readable files including an email address for each customer to be surveyed, the method comprising the steps of:
a) placing in a customer database, a list of customers to be surveyed with associated email addresses from said computer readable files;
b) sending a survey form to an internet server;
c) sending an email to each customer in the customer list, each email including customer identification and a link to said customer database via said internet server;
d) at least one customer responding to said survey by establishing the link in the respective email to link said one customer to said internet server, said link including said customer identification information, said at least one customer completing said survey and saving said completed survey on said internet server; and
e) transmitting said completed survey and said customer identification from said internet server to said customer database wherein said completed survey and associated customer identification may be analyzed.

2. The method of claim 1 wherein step c includes establishing a unique Universal Resource Locator (URL) for each customer to be surveyed, and including such a respective unique URL in each customer email, and wherein step d includes said at least one customer establishing a link to the respective unique URL for that at least one customer.

3. The method of claim 1 wherein step d further comprises blocking said at least one customer from using the respective link after the completed survey is saved.

4. The method of claim 1 wherein a firewall is established between said customer database and said internet server, and wherein step b comprises propagating said survey from said customer database through said firewall to said internet server.

5. The method of claim 4 wherein step e comprises propagating said completed survey and customer information through said firewall from said internet server to a depositor replica accessible by an application on the customer database side of the firewall.

6. The method of claim 5 wherein said application accesses said depositor replica and analyzes said completed survey and said customer information to prepare reports, and stores said completed survey, customer information, and reports on said customer database.

7. A computer program product comprising a computer usable medium having computer readable program code means therein for surveying customers having data in computer readable files including an email address for each customer to be surveyed, said computer readable program code means in said computer program product comprising:
a) computer readable program code means for placing in a customer database, a list of customers to be surveyed with associated email addresses from said computer readable files;
b) computer readable program code means for sending a survey form to an internet server;
c) computer readable program code means for sending an email to each customer in the customer list, each email including customer identification and a link to said customer database via said internet server; and
d) computer readable program code means for analyzing said completed survey and customer information received from said internet server after the completed survey and customer information is saved by at least one customer responding to said survey by establishing the link in the respective email to link said one customer to said internet server, said link including said customer identification information.

8. The program product of claim 7 wherein c includes computer readable program code means for establishing a unique Universal Resource Locator (URL) for each customer to be surveyed, and including such a respective unique URL in each customer email whereby said at least one customer may establish a link to the respective unique URL for that at least one customer.

9. The program product of claim 7 further comprising computer readable program code means for blocking said at least one customer from using the respective link after the completed survey is saved.

10. The program product of claim 7 wherein a firewall is established between said customer database and said internet server, and said program product comprises computer readable program code means for propagating said survey from said customer database through said firewall to said internet server.

11. The program product of claim 10 further comprising computer readable program code means for propagating said completed survey and customer information through said firewall from said internet server to a depositor replica accessible by an application on the customer database side of the firewall.

12. The program product of claim 11 further comprising computer readable program code means for accessing said depositor replica and analyzing said completed survey and said customer information to prepare reports, and store said completed survey, customer information, and reports on said customer database.

13. A system for surveying customers having data in computer readable files including an email address for each customer to be surveyed, the system comprising:
means for placing in a customer database, a list of customers to be surveyed with associated email addresses from said computer readable files;
means for sending a survey form to an internet server;
means for sending an email to each customer in the customer list, each email including customer identification and a link to said customer database via said internet server;
means for at least one customer responding to said survey by establishing the link in the respective email to link said one customer to said internet server, said link including said customer identification information, said at least one customer completing said survey and saving said completed survey on said internet server; and
means for transmitting said completed survey and said customer identification from said internet server to said customer database wherein said completed survey and associated customer identification may be analyzed.

14. The system of claim 13 further comprising means for establishing a unique Universal Resource Locator (URL) for each customer to be surveyed, and including such a respective unique URL in each customer email, and wherein said at least one customer establishes a link to the respective unique URL for that at least one customer.

15. The system of claim 13 further comprising means for blocking said at least one customer from using the respective link after the completed survey is saved.

16. The system of claim 13 further comprising a firewall between said customer database and said internet server, and comprising means for propagating said survey from said customer database through said firewall to said internet server.

17. The system of claim 16 further comprising an application on the customer database side of the firewall, a depositor replica on the customer database side of the firewall and accessible by said application, and means for propagating said completed survey and customer information through said firewall from said internet server to said depositor replica.

18. The system of claim 17 wherein said application includes means for accessing said depositor replica and analyzing said completed survey and said customer information to prepare reports, and for storing said completed survey, customer information, and reports on said customer database.

19. A system for surveying customers having data in computer readable files including an email address for each customer to be surveyed, the system comprising:
a customer database for storing a list of customers to be surveyed with associated email addresses taken from said computer readable files;
a survey tool which sends a survey form to an internet server;
said survey tool further sending an email to each customer in the customer list, each email including customer identification and a link to said customer database via said internet server; and
said survey tool further analyzing said completed survey and customer information received from said internet server after the completed survey and customer information is saved by at least one customer responding to said survey by establishing the link in the respective email to link said one customer to said internet server, said link including said customer identification information means for at least one customer responding to said survey by establishing the link in the respective email to link said one customer to said internet server.

20. The system of claim 19 wherein said survey tool further establishes a unique Universal Resource Locator (URL) for each customer to be surveyed, and includes such a respective unique URL in each customer email to be used by said at least one customer to establish a link to the respective unique URL for that at least one customer.

21. The system of claim 19 wherein said survey tool further blocks said at least one customer from using the respective link after the completed survey is saved.

22. The system of claim 19 further comprising a firewall between said customer database and said internet server, and said survey tool propagates said survey from said customer database through said firewall to said internet server.

23. The system of claim 22 further comprising a depositor replica on the customer database side of the firewall and accessible by said survey tool, said survey tool further propagates said completed survey and customer information through said firewall from said internet server to said depositor replica.

24. The system of claim 23 wherein said survey tool accesses said depositor replica and analyses said completed survey and said customer information to prepare reports, and stores said reports on said customer database
